(19) United States
(12) Patent Application Publication
(10) Pub. No.: US 2008/0243943 A1
(43) Pub. Date: Oct. 2, 2008

(54) Method and apparatus for efficient execution of interprocedural transactional memory code while maintaining safety

(76) Inventors: Shih-wei Liao, San Jose, CA (US); Xin Qi, Redwood City, CA (US); Chen Fu, San Jose, CA (US); Wei Li, Redwood City, CA (US)

Correspondence Address: INTEL CORPORATION;c/o INTELLEVATE, LLC, P.O. BOX 52050, MINNEAPOLIS, MN, 55402, US

(21) Appl. No.: 11/728,781

(22) Filed: Mar. 27, 2007

(51) Int. Cl. G06F 12/00

(52) U.S. Cl. 707/201; 707/E17.007

(57) ABSTRACT

In some embodiments, a method and apparatus for efficient execution of interprocedural transactional memory code while maintaining safety are presented. In this regard, a transaction agent is introduced to start a transactional memory transaction from a first procedure of a program, and to end the transaction from a second procedure of the program. Other embodiments are also disclosed and claimed.

### FIELD OF THE INVENTION

Embodiments of the present invention generally relate to the field of transactional memory, and, more particularly to a method and apparatus for efficient execution of interprocedural transactional memory code while maintaining safety.

### BACKGROUND OF THE INVENTION

Transactional memory is a software and/or hardware support for improving software productivity. Transactional Memory (TM) is a concurrency control mechanism, which serves as an alternative to locking. Usually TM is implemented with some optimistic concurrency control mechanism, i.e. a transaction is started assuming there are no conflicts, and once there is one, it is rolled back and restarted. Some typical advantages of TM over locking are freedom from locking errors, e.g. deadlock and livelock, ease of reasoning, since transactions can only be disjoint to each other or nested within others, and ease of getting higher concurrency, especially when transactions are small.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the transaction agent, in accordance with one example embodiment of the invention;

FIG. 2 is a block diagram of an example transaction agent architecture, in accordance with one example embodiment of the invention;

FIG. 3 is a flow chart of an example method for efficient execution of interprocedural transactional memory code while maintaining safety, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

Embodiments of the present invention are generally directed to a method and apparatus for efficient execution of interprocedural transactional memory code while maintaining safety. In this regard, in accordance with but one example implementation of the broader teachings of the present invention, a transaction agent is introduced. In accordance with but one example embodiment, the transaction agent employs an innovative method to support transactional memory transactions that start and end in different procedures. According to one example method, the transaction agent may type check for transaction starts and ends, translate into Java bytecode, and run the transactional memory system. As used herein, different procedures can include subroutines, “if-then-else” statements, loops, or any transaction that goes across the boundaries of language constructs. To safely support interprocedural transactions, i.e. those that start and end in different procedures, the present invention also extends the procedure declaration and corresponding type checking algorithm to verify safety criteria in a modular way (i.e. no whole program analysis required). In one embodiment, transactions need to be ended explicitly and for any two transactions, they need to be disjoint, or one needs to be nested in the other, i.e. no overlapping transactions.

FIG. 1 is a block diagram of an example electronic appliance suitable for implementing the transaction agent, in accordance with one example embodiment of the invention. Electronic appliance 100 is intended to represent any of a wide variety of traditional and non-traditional electronic appliances, laptops, desktops, servers, disk drives, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, system memory 106, expansion controller 108, transaction agent 110, storage device 112 and input/output device 114 coupled as shown in FIG. 1. Transaction agent 110, as described more fully hereinafter, may well be used in electronic appliances of greater or lesser complexity than that depicted in FIG. 1. Also, the innovative attributes of transaction agent 110 as described more fully hereinafter may well be embodied in any combination of hardware and software. While shown as being part of memory controller 104, transaction agent 110 may well be a separate component or part of another component, for example processor(s) 102. Additionally, transaction agent 110 may be implemented in software or a combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, processor(s) 102 include L1 cache (not shown) which may log open transactions and L2 cache (not shown) which may store committed transactions.

Memory controller 104 may represent any type of chipset or control logic that interfaces system memory 106 with the other components of electronic appliance 100. In one embodiment, the connection between processor(s) 102 and memory controller 104 may be referred to as a front-side bus. In another embodiment, memory controller 104 may be referred to as a north bridge. In another embodiment, memory controller 104 may communicate over a point-to-point link.

System memory 106 may represent any type of memory device(s) used to store data and instructions that may have been or will be used by processor(s) 102. Typically, though the invention is not limited in this respect, system memory 106 will consist of dynamic random access memory (DRAM). In one embodiment, system memory 106 may consist of Rambus DRAM (RDRAM). In another embodiment, system memory 106 may consist of double data rate synchronous DRAM (DDRSDRAM). The present invention, however, is not limited to the examples of memory mentioned here.

Expansion controller 108 may represent any type of chipset or control logic that interfaces expansion devices with the other components of electronic appliance 100. In one embodiment, expansion controller 108 may be referred to as a south bridge. In one embodiment, expansion controller 108 complies with Peripheral Component Interconnect (PCI) Express Base Specification, Revision 1.0, PCI Special Interest Group, released Apr. 29, 2002.

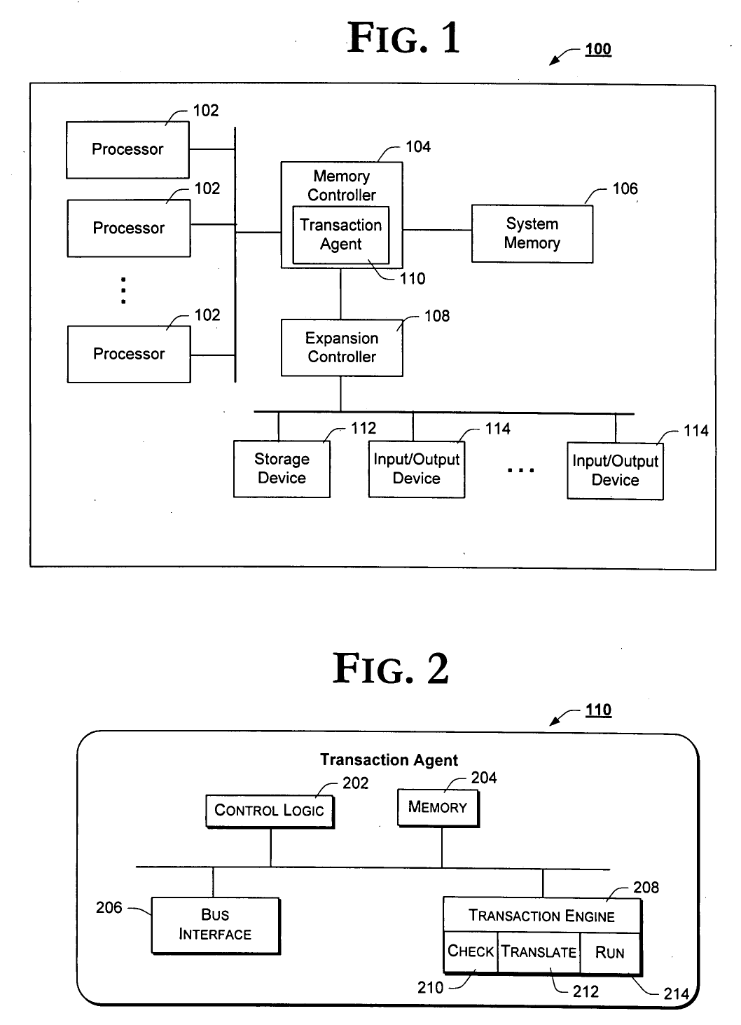

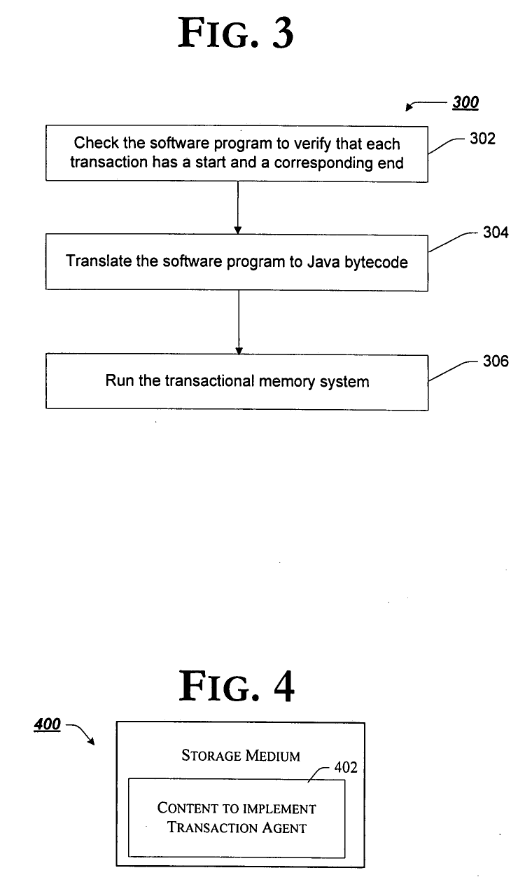

Transaction agent 110 may have an architecture as described in greater detail with reference to FIG. 2. Transaction agent 110 may also perform one or more methods to accelerate application launch, such as the method described in greater detail with reference to FIG. 3.

Storage device 112 may represent any storage device used for the long term storage of data. In one embodiment, storage device 112 may be a hard disk drive.

Input/output (I/O) device(s) 114 may represent any type of device, peripheral or component that provides input to or processes output from electronic appliance 100. In one embodiment, though the present invention is not so limited, I/O device 114 may include a network interface controller.

FIG. 2 is a block diagram of an example transaction agent architecture, in accordance with one example embodiment of the invention. As shown, transaction agent 110 may include one or more of control logic 202, memory 204, bus interface 206, and transaction engine 208 coupled as shown in FIG. 2. In accordance with one aspect of the present invention, to be developed more fully below, transaction agent 110 may include a transaction engine 208 comprising one or more of check services 210, translate services 212, and/or run services 214. It is to be appreciated that, although depicted as a number of disparate functional blocks, one or more of elements 202-214 may well be combined into one or more multi-functional blocks. Similarly, transaction engine 208 may well be practiced with fewer functional blocks, i.e., with only translate services 212, without deviating from the spirit and scope of the present invention, and may well be implemented in hardware, software, firmware, or any combination thereof. In this regard, transaction agent 110 in general and transaction engine 208 in particular are merely illustrative of one example implementation of one aspect of the present invention. As used herein, transaction agent 110 may well be embodied in hardware, software, firmware and/or any combination thereof.

As introduced above, transaction agent 110 may have the ability to reduce transactional memory transaction times, thereby reducing the probability of contention and rollback, by providing extensions to start and end transactional memory transactions from separate procedures. In one embodiment, a transaction may be started in a caller and ended in a callee as demonstrated in the following example:

```
class Dispatcher {
    private Node mem_node;
    private Receiver mem_rcv;
  public dispatch(Node node) {
    final Handler o = new Handler( );
    start o;
    if (node == mem_node) mem_rcv.do(o);
    else {
      Receiver rcv = ...; // expensive computation
      mem_rcv = rcv;
      mem_node = node;
      rcv.do(o);
    }
  }
}
class Receiver {
  public do(final Handler o) ends o {
    end o;
    // some real work
  }
}
```

As used herein control logic 202 provides the logical interface between transaction agent 110 and its host electronic appliance 100. In this regard, control logic 202 may manage one or more aspects of transaction agent 110 to provide a communication interface from electronic appliance 100 to software, firmware and the like, e.g., instructions being executed by processor(s) 102.

According to one aspect of the present invention, though the claims are not so limited, control logic 202 may receive event indications such as, e.g., launch of an application. Upon receiving such an indication, control logic 202 may selectively invoke the resource(s) of transaction engine 208. As part of an example method for efficient execution of interprocedural transactional memory code while maintaining safety, as explained in greater detail with reference to FIG. 3, control logic 202 may selectively invoke check services 210 that may check a software program (such as, for example, a pattern recognition or other parallelized application that may benefit from the teachings of the present invention) to verify that each transaction has a start and a corresponding end. Control logic 202 also may selectively invoke translate services 212 or run services 214, as explained in greater detail with reference to FIG. 3, to translate the software program to Java bytecode or to run the transactional memory system, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may also include, among others: polymer memory, battery backed DRAM, RDRAM, NAND/NOR memory, flash memory, or Ovonics memory. In one embodiment, memory 204 may be a portion of system memory 106. In another embodiment, memory 204 may be part of a processor, system disk, or network cache. Memory 204 may be used to log transactions or to store instructions, for example.

Bus interface 206 provides a path through which transaction agent 110 can communicate with other components of electronic appliance 100, for example storage device 112 or I/O device 114. In one embodiment, bus interface 206 may represent a PCI Express interface.

Check services 210, as introduced above, may provide transaction agent 110 with the ability to check the software program to verify that each transaction has a start and a corresponding end. The extensions provided in the present invention include statements “start a” and “end a”, where “a” is a final reference, i.e. the object that is referenced cannot change once initialized. The “start” statement marks that a transaction starts, and the “end” statement marks that a transaction ends. The object identity referenced by “a”, together with the current thread identity, identifies a transaction, i.e. a pair “<object, thread>” serves as the transaction handler. These two statements are idempotent respectively, i.e. “start” will have no effect if the transaction is already started, and “end” will not be effective if the transaction has been ended.

Procedure declarations may also be extended. Every procedure, similar to the “throws” clause, might include a “start” clause and an “end” clause, each with a list of final references. For example, a method declared as “void m ( . . . ) starts a, b, c { . . . }” might start transactions identified by a, b, or c without ending them, in this order, and a method declared as “void n ( . . . ) ends e, f, g { . . . }” must end transactions identified by e, f, and g without starting them, in the specified order. The extension to procedure declarations ensures that the checking is modular.

As introduced above, translate services 212 may provide transaction agent 110 with the ability to translate the software program to Java bytecode. In one example embodiment, translate services 212, after the type checking by check services 210, translates the extended code to annotated Java bytecode. In one example embodiment, all “start” and “end” statements will be translated to corresponding library calls to the runtime system (run services 214). Extension to the method header may be translated to bytecode attributes of the corresponding method.

Run services 214, as introduced above, may provide transaction agent 110 with the ability to run the transactional memory system. In one embodiment run services 214, which may be integrated into the Java Virtual Machine, will map high-level operations to low-level TM support. In one embodiment, run services 214 can handle stack unwinding and rewinding to support interprocedural transactions.

FIG. 3 is a flow chart of an example method for efficient execution of interprocedural transactional memory code while maintaining safety, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 selectively invoking check services 210 to check (302) a software program to verify that each transaction has a start and a corresponding end. In one example embodiment, check services 210 alerts a programmer of any mismatch in start and end operations.

Control logic 202 may then selectively invoke translate services 212 to translate (304) the software program to Java bytecode. In one example embodiment, translate services 212 performs just-in-time (JIT) runtime compilation.

Next, run services 214 may run (306) the transactional memory system. In one embodiment, run services 214 may log transactions in memory 204 and commit transactions in memory 106 that have ended with no contention. In another embodiment, run services 214 may roll-back and reattempt a transaction when there is contention.

FIG. 4 illustrates a block diagram of an example storage medium comprising content which, when accessed, causes an electronic appliance to implement one or more aspects of the transaction agent 110 and/or associated method 300. In this regard, storage medium 400 includes content 402 (e.g., instructions, data, or any combination thereof) which, when executed, causes the appliance to implement one or more aspects of transaction agent 110, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
starting a transactional memory transaction in a first procedure of a software program;
operating on the transaction; and
ending the transaction in a second procedure of the software program.

2. The method of claim 1, further comprising:
type checking the software program to verify that the transaction that has a start has a corresponding end.

3. The method of claim 1, further comprising:
translating at least a portion of the software program to Java bytecode.

4. The method of claim 1, further comprising:
committing a result from the transaction to memory if the transaction is ended with no contention.

5. The method of claim 1, further comprising:
restarting the transaction if contention is encountered.

6. The method of claim 1, wherein the second procedure comprises:
a subroutine called from the first procedure.

7. An electronic appliance, comprising:
a processor to perform instructions from a program;
memory coupled with the processor to store program data; and
a transaction engine coupled with memory, the transaction engine to start a transactional memory transaction in the memory from a first procedure of the program, and to end the transaction from a second procedure of the program.

8. The electronic appliance of claim 7, further comprising:
the transaction engine to verify that each transaction in the program has a start and an end.

9. The electronic appliance of claim 7, further comprising:
the transaction engine to translate at least a portion of the program to Java bytecode.

10. The electronic appliance of claim 7, further comprising:
the transaction engine to commit a result from the transaction to the memory if no contention is encountered.

11. The electronic appliance of claim 7, further comprising:
the transaction engine to restart the transaction if contention is encountered.

12. The electronic appliance of claim 7, further comprising:
a network controller.

13. A storage medium comprising content which, when executed by an accessing machine, causes the accessing machine to start a transactional memory transaction in a first procedure of a software program, to operate on the contents of the transaction, and to end the transaction in a second procedure of the software program.

14. The storage medium of claim 13, further comprising content which, when executed by the accessing machine, causes the accessing machine to type check the software program to verify that each transaction that has a start has a corresponding end.

15. The storage medium of claim 13, further comprising content which, when executed by the accessing machine, causes the accessing machine to translate at least a portion of the software program to Java bytecode.

16. The storage medium of claim 13, further comprising content which, when executed by the accessing machine, causes the accessing machine to commit a result from the transaction to memory if no contention is encountered.

17. The storage medium of claim 13, further comprising content which, when executed by the accessing machine, causes the accessing machine to roll back the transaction if contention is encountered.
